(19) United States
(12) Patent Application Publication
(10) Pub. No.: US 2024/0248770 A1
(43) Pub. Date: Jul. 25, 2024

(54) SELECTIVELY PREVENTING RESOURCE OVERALLOCATION IN A VIRTUALIZED COMPUTING ENVIRONMENT

(71) Applicant: VMware LLC, Palo Alto, CA (US)

(72) Inventors: Daniel Pavlov, Sofia (BG); Mihail Mihaylov, Sofia (BG); Jose Francisco Dillet Alfonso, Plovdiv (BG); Petar Mitrov, Sofia (BG); Atanas Shindov, Sofia (BG)

(73) Assignee: VMware LLC, Palo Alto, CA (US)

(21) Appl. No.: 18/101,412

(22) Filed: Jan. 25, 2023

(51) Int. Cl. G06F 9/50; G06F 9/455

(52) U.S. Cl. CPC G06F 9/5077; G06F 9/45558; G06F 2009/4557; G06F 2009/45595

(57) ABSTRACT

The present disclosure is related to devices, systems, and methods for selectively preventing resource overallocation in a virtualized computing environment. One example includes instructions to receive a request to prevent overallocation of a resource in a software-defined datacenter associated with a customer, determine an amount of the resource available to the customer, and assign a respective portion of the amount of the resource available to the customer to each of a plurality of virtual computing instances (VCIs) irrespective of a power state of each of the plurality of VCIs.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may utilize data storage and/or data processing services from the provider in order to run applications that handle the enterprises' core business and operational data. The applications may be proprietary and used exclusively by the enterprise or made available through a network for anyone to access and use.

Virtual computing instances (VCIs), such as virtual machines and containers, have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software-defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

### BRIEF DESCRIPTION OF THE DRAWINGS

FIG. 1 is a diagram of a host and a system for selectively preventing resource overallocation in a virtualized computing environment according to one or more embodiments of the present disclosure.

FIG. 2 illustrates a method for selectively preventing resource overallocation in a virtualized computing environment according to one or more embodiments of the present disclosure.

FIG. 3 is a diagram of a system for selectively preventing resource overallocation in a virtualized computing environment according to a number of embodiments of the present disclosure.

FIG. 4 is a diagram of a machine selectively preventing resource overallocation in a virtualized computing environment according to a number of embodiments of the present disclosure.

### DETAILED DESCRIPTION

As referred to herein, a virtual computing instance (VCI) covers a range of computing functionality. VCIs may include non-virtualized physical hosts, virtual machines (VMs), and/or containers. A VM refers generally to an isolated end user space instance, which can be executed within a virtualized environment. Other technologies aside from hardware virtualization that can provide isolated end user space instances may also be referred to as VCIs. The term “VCI” covers these examples and combinations of different types of VCIs, among others. VMs, in some embodiments, operate with their own guest operating systems on a host using resources of the host virtualized by virtualization software (e.g., a hypervisor, virtual machine monitor, etc.).

Multiple VCIs can be configured to be in communication with each other in an SDDC. In such a system, information can be propagated from a client (e.g., an end user) to at least one of the VCIs in the system, between VCIs in the system, and/or between at least one of the VCIs in the system and a server. SDDCs are dynamic in nature. For example, VCIs and/or various application services, may be created, used, moved, or destroyed within the SDDC. When VCIs are created, various processes and/or services start running and consuming resources. As used herein, “resources” are physical or virtual components that have a finite availability within a computer or SDDC. For example, resources include processing resources, memory resources, electrical power, and/or input/output resources.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

The present disclosure allows selective prevention of resource overallocation in a virtualized environment using a development platform. A development platform can be used to configure and/or provision resources in a virtualized environment. One example of such a development platform is vRealize Automation (vRA). vRA is a cloud management layer that sits on top of different clouds. It can provision complex deployments and offer governance and management of these workloads and the resources in the cloud. vCenter (vSphere) is one of the private clouds that vRA supports. Though the example of vRA is discussed herein, embodiments of the present disclosure are not so limited. A development platform in accordance with the present disclosure can be designed to automate multiple clouds with secure, self-service provisioning.

In a management platform, such as vCenter, if a VCI is turned off it is not using resources, such as memory resources and/or central processing unit (CPU) resources. As a result, in previous approaches, users can create VCIs but not always turn them on. If all the resources in a cluster on which the VCI was created are in use, then new VCIs can be created but not turned on. This leads to resource overallocation. For example, a cluster can be provisioned with 100 GB of memory. A user can create six VCIs, each taking 20 GB of memory. The total memory allocation of the VCIs is 120 GB, so at any given time only five of these VCIs can be turned on because of the total amount of memory in the cluster. The sixth VCI and any other new VCIs cannot be turned on unless one of the first five is turned off.

Some users though may desire resources to be assigned (e.g., permanently assigned) to VCIs so that they are able to turn all of the VCIs on at a given time, even if they were turned off. However, previous approaches may not be able to prevent resource overallocation. Additionally, some users may desire the ability to set specific configurations, both globally for the whole system and on the specific cluster level, that would allow them to either overallocate or underallocate a concrete amount of resources. The management platform may keep track of the available resources and the development platform can query the management platform for metrics corresponding to available resources, but in previous approaches these metrics do not factor in any VCIs that are powered off.

Embodiments of the present disclosure can collect data from a management platform about each individual VCI and each cluster. Based on this data, the amount of allocated resources (e.g., memory, CPU, storage, etc.) can be determined while factoring in powered-off VCIs. As a result, users can specify whether the development platform is to prevent overallocation of resources. In some embodiments, overallocation prevention can be prevented for all resources. In some embodiments, overallocation can be prevented for one or more particular (e.g., less than all) resources. In some embodiments, a percentage of total resources can be specified regarding resource usage (e.g., maximum resource usage).

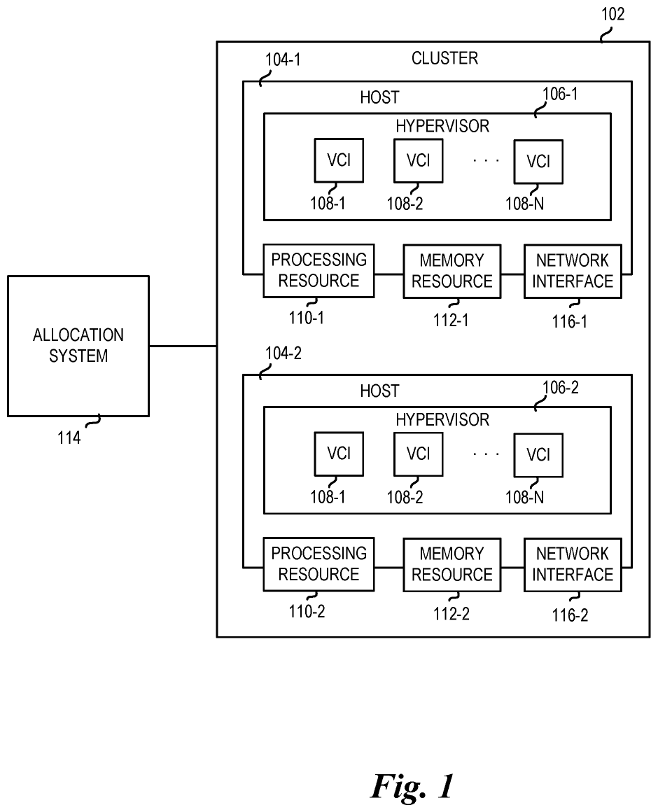

FIG. 1 is a diagram of a host and a system for selectively preventing resource overallocation in a virtualized computing environment according to one or more embodiments of the present disclosure. The system can include a cluster 102 in communication with an allocation system 114. The cluster 102 can include a first host 104-1 with processing resources 110-1 (e.g., a number of processors), memory resources 112-1, and/or a network interface 116-1. Similarly, the cluster 102 can include a second host 104-2 with processing resources 110-2, memory resources 112-2, and/or a network interface 116-2. Though two hosts are shown in FIG. 1 for purposes of illustration, embodiments of the present disclosure are not limited to a particular number of hosts. For purposes of clarity, the first host 104-1 and/or the second host 104-2 (and/or additional hosts not illustrated in FIG. 1) may be generally referred to as “host 104.” Similarly, reference is made to “hypervisor 106,” “VCI 108,” “processing resources 110,” memory resources 112,” and “network interface 116,” and such usage is not to be taken in a limiting sense.

The host 104 can be included in a software-defined data center. A software-defined data center can extend virtualization concepts such as abstraction, pooling, and automation to data center resources and services to provide information technology as a service (ITaaS). In a software-defined data center, infrastructure, such as networking, processing, and security, can be virtualized and delivered as a service. A software-defined data center can include software-defined networking and/or software-defined storage. In some embodiments, components of a software-defined data center can be provisioned, operated, and/or managed through an application programming interface (API).

The host 104-1 can incorporate a hypervisor 106-1 that can execute a number of VCIs 108-1, 108-2, . . . , 108-N (referred to generally herein as “VCIs 108”). Likewise, the host 104-2 can incorporate a hypervisor 106-2 that can execute a number of VCIs 108. The hypervisor 106-1 and the hypervisor 106-2 are referred to generally herein as a hypervisor 106. The VCIs 108 can be provisioned with processing resources 110 and/or memory resources 112 and can communicate via the network interface 116. The processing resources 110 and the memory resources 112 provisioned to the VCIs 108 can be local and/or remote to the host 104. For example, in a software-defined data center, the VCIs 108 can be provisioned with resources that are generally available to the software-defined data center and not tied to any particular hardware device. By way of example, the memory resources 112 can include volatile and/or non-volatile memory available to the VCIs 108. The VCIs 108 can be moved to different hosts (not specifically illustrated), such that a different hypervisor manages (e.g., executes) the VCIs 108. The host 104 can be in communication with the allocation system 114. In some embodiments, the allocation system 114 can be deployed on a server, such as a web server.

The allocation system 114 can include computing resources (e.g., processing resources and/or memory resources in the form of hardware, circuitry, and/or logic, etc.) to perform various operations prevent overallocation, as described in more detail herein.

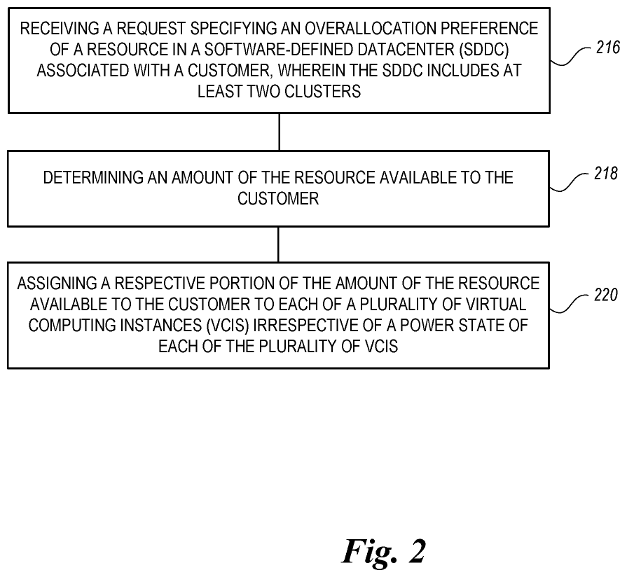

FIG. 2 illustrates a method for selectively preventing resource overallocation in a virtualized computing environment according to one or more embodiments of the present disclosure. At 216, the method can include receiving a request specifying an overallocation preference of a resource in a software-defined datacenter (SDDC) associated with a customer, wherein the SDDC includes at least two clusters. In some embodiments, a customer may be presented with an interface that provides options for specifying overallocation preferences. In some embodiments, a global configuration can be specified that relates to all resources. It is noted that the present disclosure discusses, CPU, memory, and storage, but embodiments of the present disclosure do not limit virtualized resources to such examples. If a global preference is indicated, the customer can be finished specifying preferences. In some embodiments, the customer can individually specify overallocation preferences for each resource individually in subsequent request(s), which can override the global preference.

Overallocation preferences can be made on a per-cluster basis or across all the customer's clusters. Overallocation preferences can include preventing overallocation of the resource in at least one cluster. In some embodiments, the customer can specify a percentage of the resource available to the customer to allocate to at least one of the two clusters. In some embodiments, the percentage is less than 100. For example, for a cluster with 100 GB of memory that is prevented from being overallocated, the default may be to allow up to exactly 100 GB to be allocated. If, however, the user sets 50% as the configuration, then embodiments herein can consider the cluster as having 50 GB total memory (e.g., 50% of 100 GB). In such a scenario, only half of the cluster's memory will be filled and no more VCIs will be placed in the cluster unless the user updates the percentage. Such embodiments may be useful, for instance, if a customer wants to keep the remaining percentage free for reasons such as maintenance, resizing VCIs, other workloads (e.g., containerized workloads), and/or potential outage, among others.

In some embodiments, the percentage specified is greater than 100%. For example, if the user wants to allow overallocation to a certain extent, the user can set 120% as the configuration, meaning that embodiments herein will act as if the cluster has 120 GB total memory (e.g., (120% of 100 GB). It is to be understood that a user may want to allow overallocation only on one or some of the clusters.

At 218, the method can include determining an amount of the resource available to the customer. Embodiments herein can collect data from a management platform (e.g., vCenter) about each individual VCI and each cluster. Based on this data, embodiments herein can determine the amount of allocated memory, CPU, and storage, factoring in any powered-off machines. For example, a cluster can be provisioned with 100 GB of memory and request overallocation to be prevented in accordance with the present disclosure. The user can create five VCIs, each taking 20 GB of memory. The total memory allocation of the VCIs is 100 GB, so at any given time all five of these VCIs can be turned on and suitably allocated.

At 220, the method can include assigning a respective portion of the amount of the resource available to the customer to each of a plurality of virtual computing instances (VCIs) irrespective of a power state of each of the plurality of VCIs. As previously discussed, resources can be assigned (e.g., permanently assigned) to VCIs so that a user is able to turn them on at any time, even if they were turned off. In an example, if a user wants to provision a VCI with 2 GB of RAM, they can guarantee that it will have 2 GB of RAM because embodiments herein can prevent another VCI from using that portion of the available resource.

Overallocation preferences can be determined and/or specified each time a VCI is provisioned and/or updated. In some embodiments, such preferences can be determined and/or specified by vRA's resource allocation engine, a function of which is to determine where to place the VCIs.

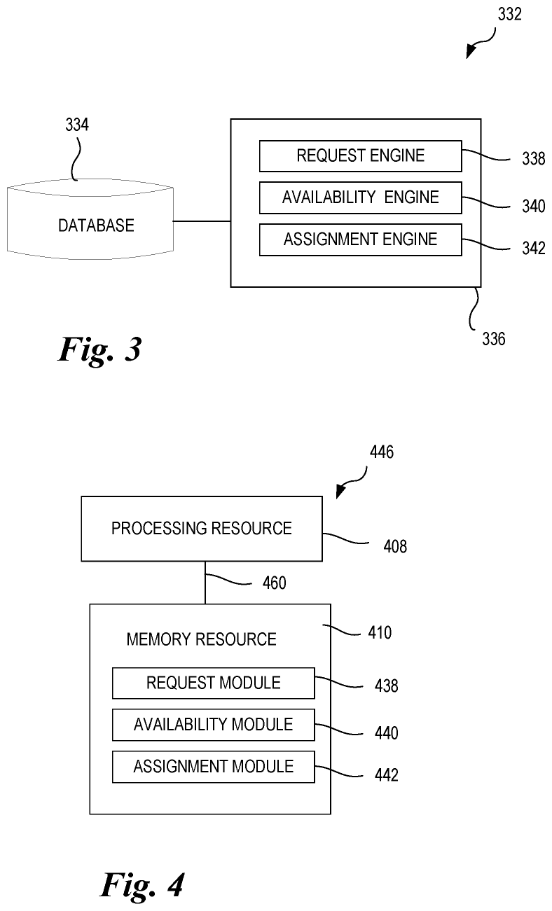

FIG. 3 is a diagram of a system 332 for selectively preventing resource overallocation in a virtualized computing environment according to a number of embodiments of the present disclosure. The system 332 can include a database 334, a subsystem 336, and/or a number of engines, for example request engine 338, availability engine 340, and/or assignment engine 342, and can be in communication with the database 334 via a communication link. The system 332 can include additional or fewer engines than illustrated to perform the various functions described herein. The system can represent program instructions and/or hardware of a machine (e.g., machine 446 as referenced in FIG. 4, etc.). As used herein, an “engine” can include program instructions and/or hardware, but at least includes hardware. Hardware is a physical component of a machine that enables it to perform a function. Examples of hardware can include a processing resource, a memory resource, a logic gate, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

In some embodiments, the request engine 338 can include a combination of hardware and program instructions that is configured to receive a request to prevent overallocation of a resource in a software-defined datacenter associated with a customer. In some embodiments, the availability engine 340 can include a combination of hardware and program instructions that is configured to determine an amount of the resource available to the customer. In some embodiments, the assignment engine 342 can include a combination of hardware and program instructions that is configured to assign a respective portion of the amount of the resource available to the customer to each of a plurality of virtual computing instances (VCIs) irrespective of a power state of each of the plurality of VCIs. The assignment engine 342 can be configured to assign a first portion of the amount of the resource available to the customer to a powered-on VCI and assign a second portion of the amount of the resource available to the customer to a powered-off VCI. Some embodiments include a power engine configured to power on each of the plurality of VCIs with each of the plurality of VCIs provisioned with its respective portion of the amount of the resource available.

FIG. 4 is a diagram of a machine 446 selectively preventing resource overallocation in a virtualized computing environment according to a number of embodiments of the present disclosure. The machine 446 can utilize software, hardware, firmware, and/or logic to perform a number of functions. The machine 446 can be a combination of hardware and program instructions configured to perform a number of functions (e.g., actions). The hardware, for example, can include a number of processing resources 408 and a number of memory resources 410, such as a machine-readable medium (MRM) or other memory resources 410. The memory resources 410 can be internal and/or external to the machine 446 (e.g., the machine 446 can include internal memory resources and have access to external memory resources). In some embodiments, the machine 446 can be a virtual computing instance (VCI) or other computing device. The term “VCI” covers a range of computing functionality. The term “virtual machine” (VM) refers generally to an isolated user space instance, which can be executed within a virtualized environment. Other technologies aside from hardware virtualization can provide isolated user space instances, also referred to as data compute nodes. Data compute nodes may include non-virtualized physical hosts, VMs, containers that run on top of a host operating system without a hypervisor or separate operating system, and/or hypervisor kernel network interface modules, among others. Hypervisor kernel network interface modules are non-VM data compute nodes that include a network stack with a hypervisor kernel network interface and receive/transmit threads. The term “VCI” covers these examples and combinations of different types of data compute nodes, among others.

The program instructions (e.g., machine-readable instructions (MRI)) can include instructions stored on the MRM to implement a particular function (e.g., an action such as assigning resources to VCIs). The set of MRI can be executable by one or more of the processing resources 408. The memory resources 410 can be coupled to the machine 446 in a wired and/or wireless manner. For example, the memory resources 410 can be an internal memory, a portable memory, a portable disk, and/or a memory associated with another resource, e.g., enabling MRI to be transferred and/or executed across a network such as the Internet. As used herein, a “module” can include program instructions and/or hardware, but at least includes program instructions.

Memory resources 410 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory, optical memory, and/or a solid state drive (SSD), etc., as well as other types of machine-readable media.

The processing resources 408 can be coupled to the memory resources 410 via a communication path 460. The communication path 460 can be local or remote to the machine 446. Examples of a local communication path 460 can include an electronic bus internal to a machine, where the memory resources 410 are in communication with the processing resources 408 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 460 can be such that the memory resources 410 are remote from the processing resources 408, such as in a network connection between the memory resources 410 and the processing resources 408. That is, the communication path 460 can be a network connection. Examples of such a network connection can include a local area network (LAN), wide area network (WAN), personal area network (PAN), and the Internet, among others.

As shown in FIG. 4, the MRI stored in the memory resources 410 can be segmented into a number of modules 438, 440, 442 that when executed by the processing resources 408 can perform a number of functions. As used herein a module includes a set of instructions included to perform a particular task or action. The number of modules 438, 440, 442 can be sub-modules of other modules. For example, the availability module 440 can be a sub-module of the request module 438 and/or can be contained within a single module. Furthermore, the number of modules 438, 440, 442 can comprise individual modules separate and distinct from one another. Examples are not limited to the specific modules 438, 440, 442 illustrated in FIG. 4.

One or more of the number of modules 438, 440, 442 can include program instructions and/or a combination of hardware and program instructions that, when executed by a processing resource 408, can function as a corresponding engine as described with respect to FIG. 3. For example, the assignment module 442 can include program instructions and/or a combination of hardware and program instructions that, when executed by a processing resource 408, can function as the assignment engine 342.

For example, the machine 446 can include a request module 438, which can include instructions to receive a request to prevent overallocation of a resource in a software-defined datacenter associated with a customer. The machine 446 can include an availability module 440, which can include instructions to determine an amount of the resource available to the customer. The machine 446 can include an assignment module 442, which can include instructions to assign a respective portion of the amount of the resource available to the customer to each of a plurality of virtual computing instances (VCIs) irrespective of a power state of each of the plurality of VCIs.

The present disclosure is not limited to particular devices or methods, which may vary. The terminology used herein is for the purpose of describing particular embodiments, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.”

The figures herein follow a numbering convention in which the first digit or digits correspond to the drawing figure number and the remaining digits identify an element or component in the drawing. Similar elements or components between different figures may be identified by the use of similar digits. For example, 108 may reference element “08” in FIG. 1, and a similar element may be referenced as 508 in FIG. 5. A group or plurality of similar elements or components may generally be referred to herein with a single element number. For example, a plurality of reference elements 104-1, 104-2, . . . , 104-N may be referred to generally as 104. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention, and should not be taken in a limiting sense.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A non-transitory machine-readable medium having instructions stored thereon which, when executed by a processor, cause the processor to:
receive a request to prevent overallocation of a resource in a software-defined datacenter associated with a customer;
determine an amount of the resource available to the customer; and
assign a respective portion of the amount of the resource available to the customer to each of a plurality of virtual computing instances (VCIs) irrespective of a power state of each of the plurality of VCIs.

2. The medium of claim 1, including instructions to:
assign a first portion of the amount of the resource available to the customer to a powered-on VCI; and
assign a second portion of the amount of the resource available to the customer to a powered-off VCI.

3. The medium of claim 1, including instructions to power on each of the plurality of VCIs with each of the plurality of VCIs provisioned with its respective portion of the amount of the resource available.

4. The medium of claim 3, wherein the amount of the resource available to the customer is not exceeded by powering on each of the plurality of VCIs.

5. The medium of claim 1, wherein the resource is storage.

6. The medium of claim 1, wherein the resource is memory.

7. The medium of claim 1, wherein the resource is a central processing unit (CPU).

8. A method, comprising:
receiving a request specifying an overallocation preference of a resource in a software-defined datacenter (SDDC) associated with a customer, wherein the SDDC includes at least two clusters;
determining an amount of the resource available to the customer; and
assigning a respective portion of the amount of the resource available to the customer to each of a plurality of virtual computing instances (VCIs) irrespective of a power state of each of the plurality of VCIs.

9. The method of claim 8, wherein receiving the request specifying the overallocation preference of the resource includes receiving a request to prevent overallocation of the resource in at least one of the two clusters.

10. The method of claim 8, wherein receiving the request specifying the overallocation preference of the resource includes receiving an indication of a percentage of the resource available to the customer to allocate to at least one of the two clusters.

11. The method of claim 10, wherein the percentage is less than one hundred percent.

12. The method of claim 10, wherein the percentage is more than one hundred percent.

13. The method of claim 8, wherein the method includes receiving a request specifying a global overallocation preference that applies to a plurality of resources.

14. The method of claim 13, wherein the request is made via a user interface.

15. The method of claim 13, wherein the method includes receiving a subsequent request modifying the global overallocation preference for at least one resource of the plurality of resources.

16. The method of claim 13, wherein the method includes receiving a subsequent request overriding the global allocation preference for a cluster of the at least two clusters.

17. A system, comprising:
a request engine configured to receive a request to prevent overallocation of a resource in a software-defined datacenter associated with a customer;
an availability engine configured to determine an amount of the resource available to the customer; and
as assignment engine configured to assign a respective portion of the amount of the resource available to the customer to each of a plurality of virtual computing instances (VCIs) irrespective of a power state of each of the plurality of VCIs.

18. The system of claim 17, wherein the resource is one of:
storage;
memory; and
a central processing unit (CPU).

19. The system of claim 17, including a power engine configured to power on each of the plurality of VCIs with each of the plurality of VCIs provisioned with its respective portion of the amount of the resource available.

20. The system of claim 17, wherein the assignment engine is configured to:
assign a first portion of the amount of the resource available to the customer to a powered-on VCI; and
assign a second portion of the amount of the resource available to the customer to a powered-off VCI.
